(19) United States
(12) Patent Application Publication
(10) Pub. No.: US 2012/0255849 A1
(43) Pub. Date: Oct. 11, 2012

(54) SLIDE SWITCH

(75) Inventor: Wakana Kawano, Makinohara-shi (JP)

(73) Assignee: YAZAKI CORPORATION, Tokyo (JP)

(21) Appl. No.: 13/518,493

(22) PCT Filed: Dec. 22, 2010
(86) PCT No.: PCT/JP2010/073253

§ 371 Date: Jun. 22, 2012

(30) Foreign Application Priority Data
Dec. 25, 2009 (JP) 2009-294210

(51) Int. Cl. H01H 15/10

(52) U.S. Cl. 200/550

(57) ABSTRACT

A purpose is to provide a slide switch so that the installation space is reduced, and the size and weight of the switch can be reduced with the reduction of the sized of components. Electric wire connecting terminals which include wire connecting parts to be press-contact to electric wires orderly accommodated in an electric wire arranging part of a switch case and fixed contacts which are formed integrally with the wire connecting parts are fixed to the electric wire arranging part so that the fixed contacts covers the electric wires accommodated in the electric wire arranging part. A slider which is supported on the switch case slidably along the arrangement direction of the fixed contacts is arranged on the electric wire arranging part so that a movable connector on the slider is laid over the fixed contacts.

### TECHNICAL FIELD

This invention is related to a slide switch.

### BACKGROUND ART

Slide switches are used in interior lights of vehicles and the like as switches for switching operational modes.

Conventionally, various slide switches have been proposed as the above-mentioned slide switches in which an electric wire arranging part in which a plurality of electric wires of a wire harness are pressed and connected, and a contact switching part which switches between connections by means of the slide of a slider are arranged side by side in a plane (refer to the following PTLs 1 and 2).

FIGS. 11 to 14 show an example of the slide switches in which the electric wire arranging part and the contact switching part are arranged side by side as mentioned above.

A slide switch 101 includes a switch case 103, three electric wire connecting terminals 104, 105 and 106, a slider 108 which is slidably supported by the switch case 103, and a movable connector 109 with which the slider 108 is equipped.

The switch case 103 is approximately box-like which opens upwards, and includes an electric wire arranging part 111 which orderly accommodates four electric wires 102a, 102b, 102c and 102d, and a contact switching part 112 into which the slider 108 is incorporated, as shown in FIGS. 12 and 13. In the switch case 103, the electric wire arranging part 111 and the contact switching part 112 are arranged side by side in a plane.

The upper opening of the electric wire arranging part 111 is covered with an arranging part cover 114 which are detachably engages with the switch case 103, as shown in FIG. 12. The upper opening of the contact switching part 112 is covered with a contact switching part cover 115 which are detachably engaged with the switch case 103.

The electric wire connecting terminals 104, 105 and 106 are press-formed products of metal plates, and in which, as shown in FIG. 13, electric wire connecting parts 104a, 105a and 106a which are placed in the electric wire arranging part 111, belt-shaped plates 104b, 105b and 106b which extend vertically upwards from the ends of the electric wire connecting parts 104a, 105a and 106a at one side, and fixed contacts 104c, 105c and 106c which extend horizontally from the upper ends of the belt-shaped plates 104b, 105b and 106b are respectively formed.

The electric wire connecting parts 104a, 105a and 106a are pressing and connecting parts which cut the sheaths of the electric wires with pressing and connecting blades to conductively connect to the conductors of the electric wires.

The belt-shaped plates 104b, 105b and 106b are provided to extend vertically upwards along a partition wall 113 between the electric wire arranging part 111 and the contact switching part 112 of the switch case 103.

As shown in FIG. 13, the fixed contacts 104c, 105c and 106c are provided to extend to the contact switching part 112 from the upper ends of the belt-shaped plates 104b, 105b and 106b, respectively. The fixed contacts 104c, 105c and 106c are contacts which the movable connector 109 of the slider 108 slides on and contacts with, and are arranged side by side in a row in the longitudinal direction (arrow X1 direction in FIG. 13) of the contact switching part 112. Each of the fixed contacts 104c, 105c and 106c has a convex spherical contact Fc towards the lower part (inwards of the contact switching part 112), as shown in FIG. 14.

Each of the electric wire connecting terminals 104, 105 and 106 is fixed to the switch case 103 by engaging the belt-shaped plates 104b, 105b and 106b with locking grooves 113a which are provided on the partition wall 113.

As shown in FIG. 14, the slider 108 is installed in the contact switching part 112 slidably along the arranging direction (arrow X2 direction of FIG. 14) of the above-mentioned fixed contacts 104c, 105c and 106c.

The slider 108 accommodates inside a ball 121 for giving moderation at the time of sliding, a spring 125 which presses the ball 121 to a wave-like cam surface 123 on the bottom of the contact switching part 112, and the above-mentioned movable connector 109, as shown in FIG. 14. At the time of sliding the slider 108, the movement of the ball 121 that climbs over the cam surface 123 by overcoming the restoring force of the spring 125 and fails into the valley of the cam surface 123 gives moderateness.

The movable connector 109 is urged by the spring 125 to the side of the fixed contacts 104c, 105c and 106c, as shown in FIG. 14. The movable connector 109 connects or short circuits two adjacent spherical contacts Fc according to the movement position of the slider 108.

### CITATION LIST

### Patent Literatures

[PTL 1] JP-A-2002-218635

[PTL 2] JP-A-2006-62640

### SUMMARY OF INVENTION

### Technical Problem

However, since the electric wire arranging part 111 and the contact switching part 112 are arranged side by side in a plane in the above-mentioned slide switch 101 as shown in FIGS. 12 and 13, the dimensions in the plane become large and there is a problem that a large installation space is needed at the time of installation.

Since these components such as the electric wire connecting terminals 104, 105 and 106 and the switch case 103 become large, there is also a problem that the weight of the switch increases.

Thus, a purpose of the invention is to provide a slide switch so that the above problems are solved, the installation space is reduced, and the sizes and weights of the components can be reduced.

### Solution to Problem

The purpose of the invention mentioned above is achieved by means of the following structures.

(1) A slide switch comprising:

a switch case which includes an electric wire arranging part which orderly accommodates a plurality of electric wires;

a plurality of electric wire connecting terminals, each of which includes electric wire connecting parts which are conductively connected to the electric wires at the electric wire arranging part and a fixed contact which is formed integrally with the electric wire connecting parts and is fixed to the switch case;

a slider which is supported by the switch case slidably along an arranging direction of the plurality of fixed contacts on the switch case; and

a movable connector which is equipped in the slider so that the fixed contact with which the movable connector is conductively connected is changed in accordance with a slide of the slider, wherein

the electric wire connecting terminals are fixed to the electric wire arranging part so that the fixed contacts cover the electric wires accommodated in the electric wire arranging part, and

the slider is slidably supported on the electric wire arranging part so that the movable connector is laid over the fixed contacts.

(2) The slide switch according to above (1), wherein a position where the movable connector slides is set so that the movable connector does not contact the electric wires which are press-contacted to the electric wire connecting terminals.

(3) The slide switch according to above (2), wherein the electric wire arranging part includes electric wire accommodating slots which orderly accommodate the electric wires, a depth of the electric wire accommodating slots is larger than an outer diameter of the electric wires so that the electric wires are accommodated inside the electric wire accommodating slots in a sunk state, and a movement of the movable connector towards a side of the electric wires is regulated by an upper surfaces of groove-shaped walls which define the electric wire accommodating slots.

(4) The slide switch according to any one of above (1) to (3), wherein each of the electric wire connecting terminals has a U shape viewed from side by a pair of the electric wire connecting parts which are arranged to be opposite to each other and spaced in a longitudinal direction of the electric wires, and the fixed contact which connects upper ends of the pair of electric wire connecting parts.

According to the structure of the above (1), the fixed contacts of the electric wire connecting terminals are arranged on the electric wires accommodated in the electric wire arranging part of the switch case, and the movable connector on the slider is further laid over the fixed contacts. That is, since the electric wire arranging part in which the plurality of electric wires of the wire harness are press-contacted and the contact switching part which switches between connections by means of the slide of the slider are formed by arranging the switching part to be laid over the electric wire arranging part, the dimensions in the plane are cut down. Therefore, the installation space can be reduced.

By arranging the electric wire arranging part to be laid over the contact switching part, the sizes of the components such as the electric wire connecting terminals can be reduced, and the size and the weight of the slide switch can be reduced with the reduction of the sizes of these components.

The arrangement of the wire harness which attaches to the slide switch can be improved with the reduction of the size of the slide switch.

According to the structure of the above (2), since the movable connector on the slider does not contact the electric wires at the time of sliding operation, wear of the electric wire sheaths due to the rub of the movable connector can be prevented, and the operational reliability and endurance of the slide switch can be improved.

According to the structure of the above (3), the movement position of the movable connector can be definitely regulated by the upper surfaces of the groove-shaped walls which define the electric wire accommodating slots to the position where the electric wires in the electric wire accommodating slots are not contacted. With the structure in which the upper surfaces of the groove-shaped walls which define the electric wire accommodating slots which position the electric wires are also used to regulate the movement position of the movable connector, since a guide structure exclusively used to regulate the movement position of the movable connector or the like is not necessary, the structure of the switch case can also be prevented from becoming complicated.

According to the structure of the above (4), for example, the electric wire connecting terminals can be easily fixed to the electric wire accommodating slots with stable postures by fitting the pair of the electric wire connecting parts located at the two ends of the fixed contacts between the groove-shaped walls of the electric wire accommodating slots, the operation of fixing to the switch case of the electric wire connecting terminals can be simplified, and the assembly of the slide switch can be improved.

### BRIEF DESCRIPTION OF DRAWINGS

FIG. 1 is a perspective view from the front side of one embodiment of an in-vehicle illuminating device into which a slide switch according to the invention is incorporated.

FIG. 2 is a back view of the in-vehicle illuminating device shown in FIG. 1.

FIG. 3 is a B-B sectional view of the slide switch shown in FIG. 2.

FIG. 4 is a view taken along a line C-C of FIG. 3.

FIG. 5 is a top view of an electric wire arranging part of the switch case shown in FIG. 4.

FIG. 6 is a perspective view of a plurality of electric wires of a wire harness accommodated in the electric wire arranging part shown in FIG. 5 and electric wire connecting terminals connected to these electric wires.

FIG. 7 is a top view of a slider assembly used in the slide switch shown in FIG. 2.

FIG. 8 is a D-D sectional view of FIG. 7.

FIG. 9 is an exploded perspective view of the slider assembly shown in FIG. 7.

FIGS. 10A to 10C are top views which show fixed contacts which are connected or short circuited by a movable connector of the slider for every movement position of the slider for the slide switch shown in FIG. 2. FIG. 10A is a top view which shows a connection state when the slider is located at the left end in the figure, in which electric wire connecting terminals are connected or short circuited by the movable connector, FIG. 10B is a top view which shows a connection state when the slider is moved only one moderation from the left end in the figure to the right side, in which electric wire connecting terminals are connected or short circuited by the movable connector, and FIG. 10C is a top view which shows a connection state when the slider is slid and moved to the right end in the figure, in which the movable connect only connects one electric wire connecting terminal.

FIG. 11 is a perspective view of the profile of a conventional slide switch.

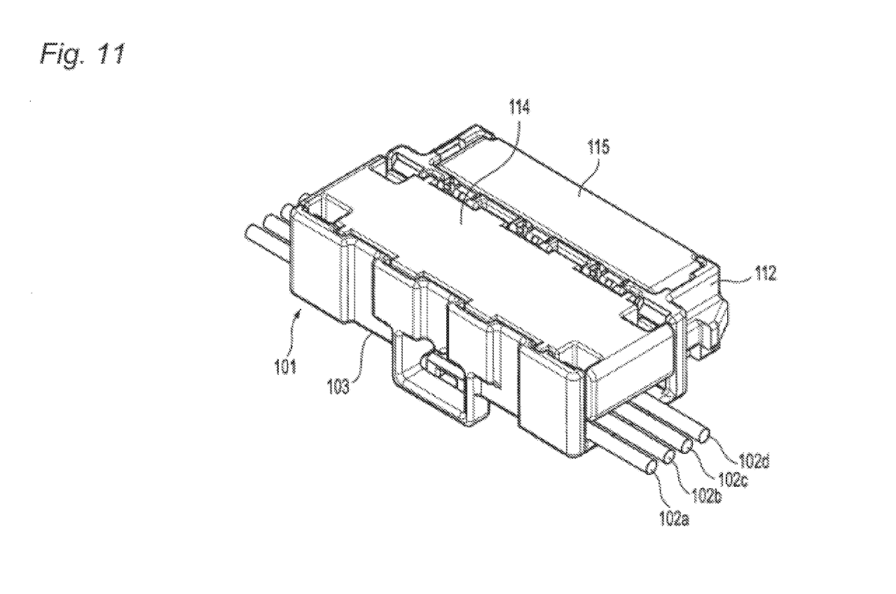

FIG. 12 is an exploded perspective view of the electric wire arranging part of the slide switch shown in FIG. 11.

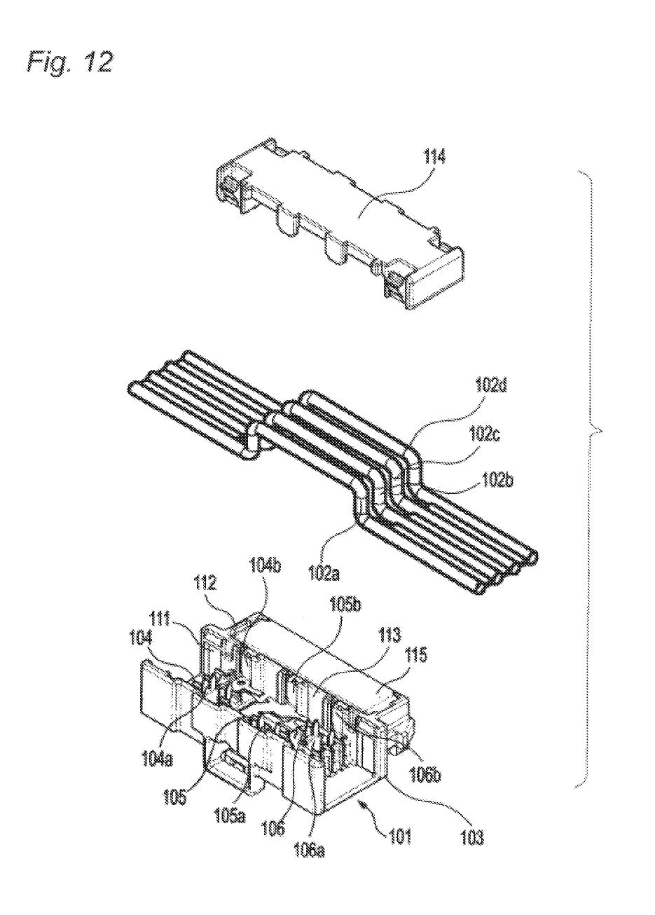

FIG. 13 is a top view when an arranging part cover and a contact switching part cover of the slide switch of FIG. 11 are removed.

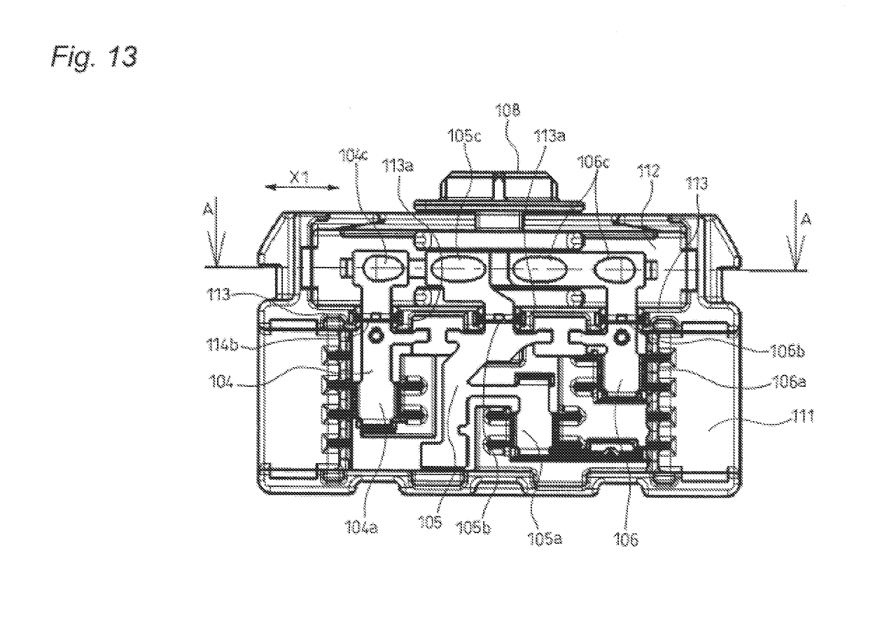

FIG. 14 is an A-A sectional view of FIG. 13.

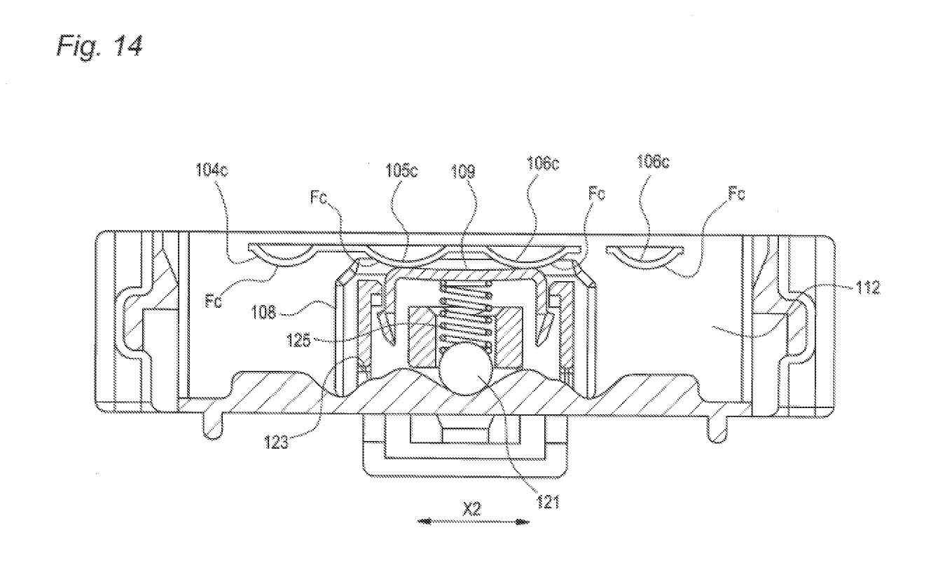

### DESCRIPTION OF EMBODIMENTS

Next, preferred embodiments of the slide switch according to the invention will be explained in detail with reference to the figures.

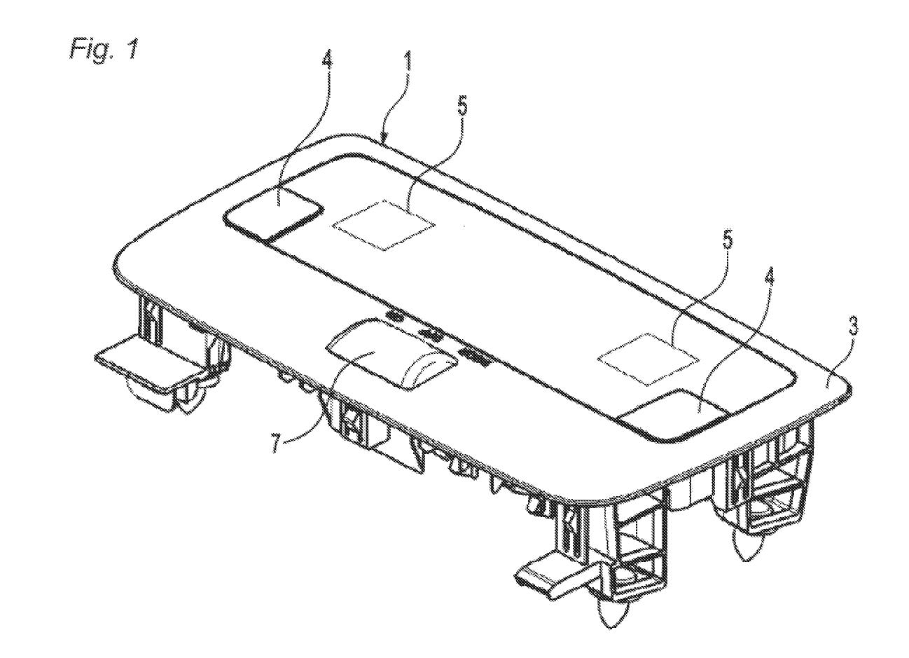

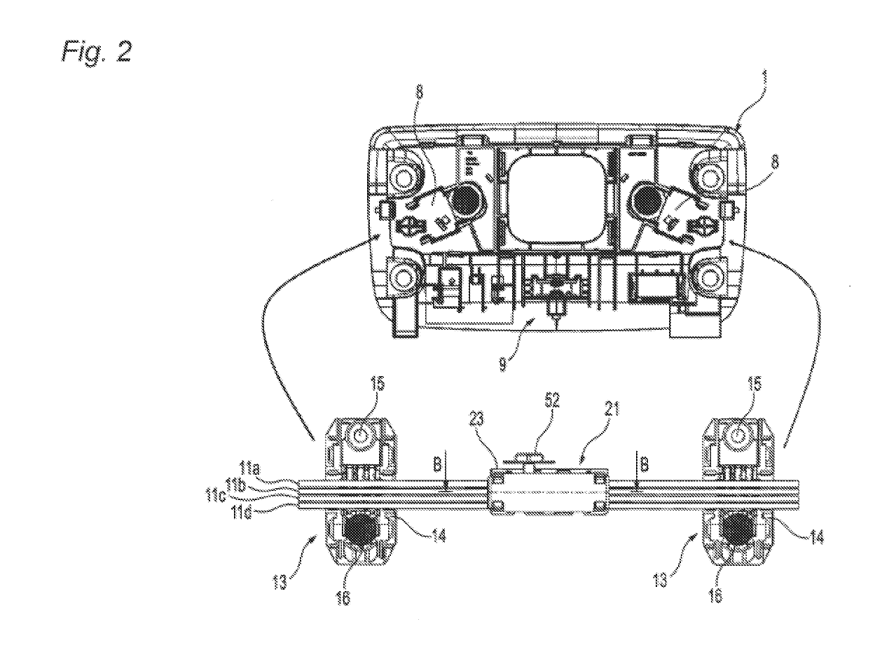

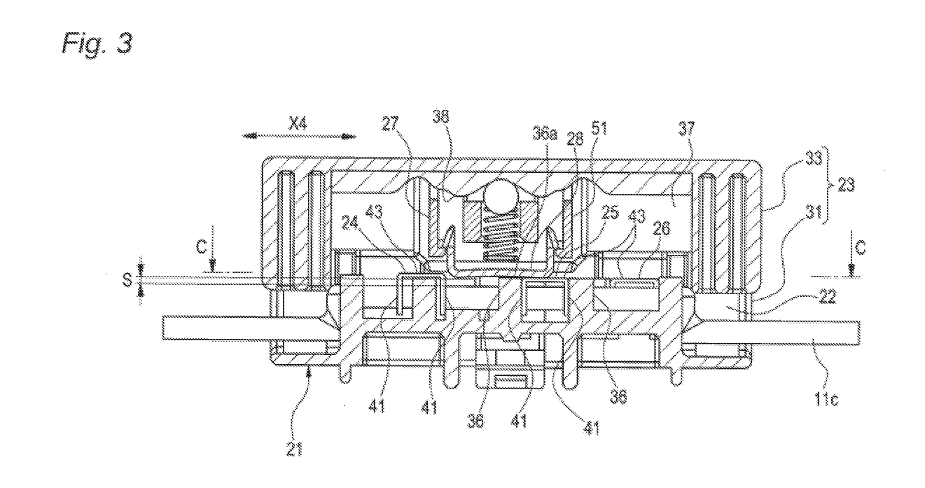

FIG. 1 is a perspective view from the front side of one embodiment of an in-vehicle illuminating device into which a slide switch according to the invention is incorporated. FIG. 2 is a back view of the in-vehicle illuminating device shown in FIG. 1. FIG. 3 is a B-B sectional view of the slide switch shown in FIG. 2.

The in-vehicle illuminating device 1 shown in FIGS. 1 and 2 is an interior light which is installed on the ceiling of a vehicle. The front side (interior side) surface of the in-vehicle illuminating device 1, as shown in FIG. 1, has a designed structure in which pushing parts 4 for pushing switches, light projecting lens 5, and a knob 7 for slide operations are arranged inside a bezel 3 which is a designed frame that is attached to a lamp installing window of a wall member for internal decoration.

The pushing parts 4 and the light projecting lens 5 are arranged left-right symmetrically at the front side surface of the in-vehicle illuminating device 1. The knob 7 for slide operations is arranged to be close to one side edge of the front side surface of the in-vehicle illuminating device 1.

At the rear side surface of the in-vehicle illuminating device 1, as shown in FIG. 2, illuminating part receiving parts 8 are provided left-right symmetrically, and a switch receiving part 9 is provided at a position corresponding to the installing position of the knob 7 for slide operations.

Illuminating parts 13 which are attached to four (a plurality of) electric wires 11a, 11b, 11c and 11d which form a wire harness are installed to the left and right illuminating part receiving parts 8, respectively.

The illuminating part 13, as shown in FIG. 2, includes a push switch 15 corresponding to the pushing part 4 which is arranged at the front side surface of the in-vehicle illuminating device 1, and a bulb (lamp) 16 for irradiating light to the light projecting lens 5 on an illuminating part frame 14 which can be attached and detached to and from the illuminating part receiving part 8.

A slide switch 21 which is attached to the four electric wires 11a, 11b, 11c and 11d which form the wire harness between the pair of illuminating parts 13 is installed into the switch receiving part 9, as shown in FIG. 2.

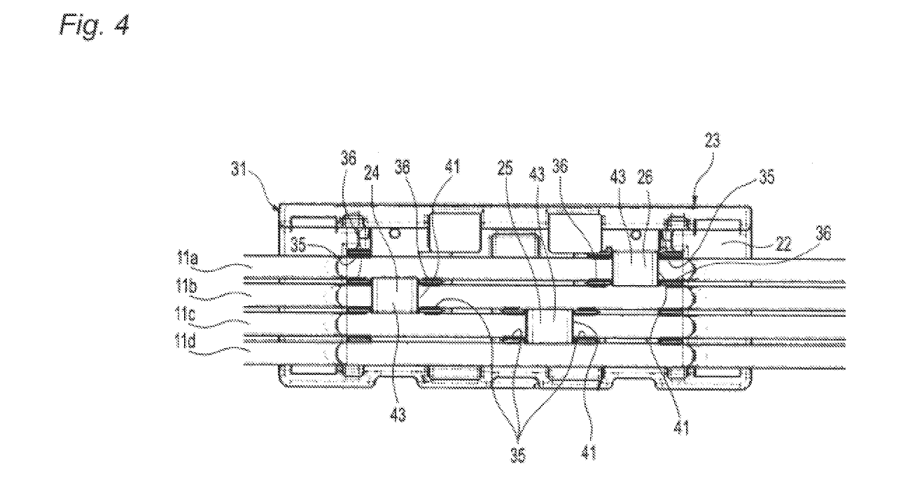

The slide switch 21 includes, as shown in FIG. 3 and FIG. 4, a switch case 23 which includes an electric wire arranging part 22 which accommodates orderly the four above-mentioned electric wires 11a, 11b, 11c and 11d, three electric wire connecting terminals 24, 25 and 26 which are fixed to the switch case 23, a slider 27 which is slidably supported by the switch case 23, and a movable connector 28 which the slider 27 is equipped with.

The switch case 23 includes a first case member 31 which has the above-mentioned electric wire arranging part 22, and a second case member 33 which is coupled with the above-mentioned first case member 31 by accommodating the above-mentioned slider 27.

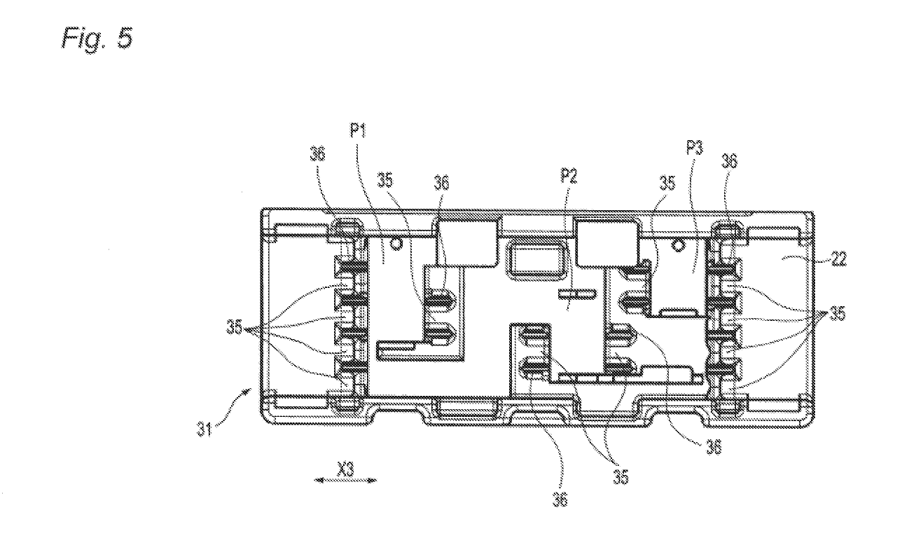

As shown in FIGS. 4 and 5, the electric wire arranging part 22 of the first case member 31 accommodates orderly the electric wires 11a, 11b, 11c, and 11 in a space which opens upwards by accommodating the electric wires in electric wire accommodating slots 35 which are arranged in positions where the electric wires 11a, 11b, 11c and 11d are inserted through.

In this embodiment, the depth of the electric wire accommodating slots 35 is set to be larger than the outer diameter of the electric wires 11a, 11b, 11c and 11d, and the electric wires 11a, 11b, 11c and 11d are accommodated to be completely sunk inside the electric wire accommodating slots 35.

The second case member 33 defines a slider accommodating space 37 which slidably accommodates the slider 27 on the electric wire arranging part 22, as shown in FIG. 3. A wave-like cam surface 38 for giving moderateness at the time of sliding the slider 27 is formed on the inner bottom (upside internal wall surface in FIG. 3) of the second case member 33.

The specific structure of the slider 27 and the structure for giving moderateness are explained in detail later.

In this embodiment, the three electric wire connecting terminals 24, 25 and 26 have the same structures. Each of the electric wire connecting terminals 24, 25 and 26 includes electric wire connecting parts 41 which are conductively connected to the electric wires accommodated in the electric wire arranging part 22, and a fixed contact 43 which is integrally formed with the electric wire connecting parts 41. In this embodiment, the electric wire connecting part 41 is a pressing and connecting part which cuts the sheath of an electric wire with a pressing and connecting blade to conductively connect to the conductor of the electric wire.

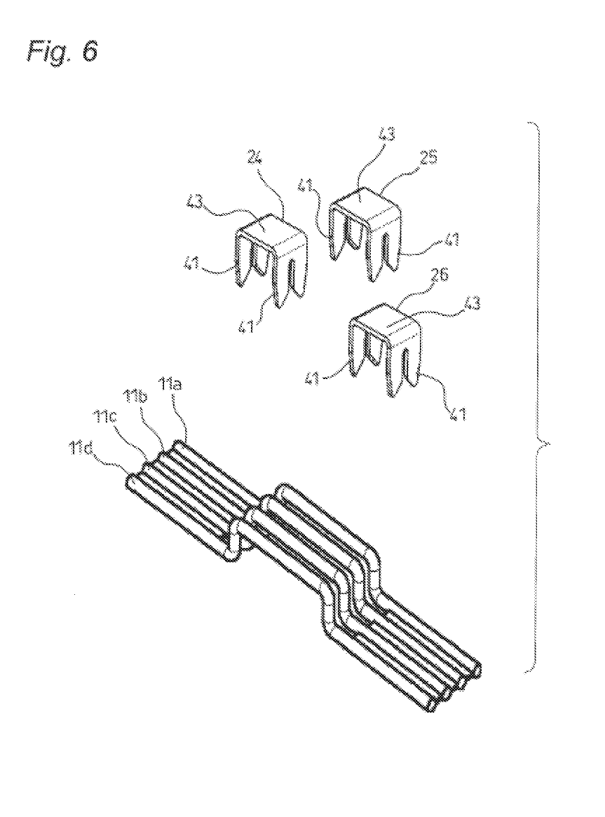

In this embodiment, as shown in FIGS. 3 and 6, each of the electric wire connecting terminals 24, 25 and 26 includes a pair of the electric wire connecting parts 41 which are arranged to be opposite to each other and spaced in the longitudinal direction of electric wires, and the fixed contact 43 which connects the upper ends of the pair of electric wire connecting parts 41 to have a U shape when viewed from side.

In this embodiment, as shown in FIG. 5, installation positions P1, P2, and P3, where the electric wire connecting terminals 24, 25 and 26 are installed, are set in the electric wire arranging part 22 by being shifted in the insertion direction of the electric wires (the arrow X3 direction of the figure). Therefore, as shown in FIG. 3, the three electric wire connecting terminals 24, 25 and 26 which are installed in these installation positions P1, P2, and P3, when viewed from side, are arranged by being shifted in positions along the length direction (insertion direction) of electric wires.

In this embodiment, groove-shaped walls 36 are raised at the two ends (two ends in the electric wire insertion direction) of the installation positions P1, P2, and P3 of the electric wire connecting terminals 24, 25 and 26 so that the pair of electric wire connecting parts 41 of each of the electric wire connecting terminals 24, 25 and 26 are held from the length direction of the electric wires. The groove-shaped walls 36 are naturally wall members which define the electric wire accommodating slots 35, respectively. However, the groove-shaped walls 36 which are provided so that the above-mentioned installation positions P1, P2, and P3 are held define gaps into which the electric wire connecting terminals 24, 25 and 26 fit, and function as terminal locking parts which fix to the electric wire arranging part 22 the electric wire connecting terminals 24, 25 and 26 which are inserted into the gaps.

That is, in this embodiment, the electric wire connecting terminals 24, 25 and 26 are fixed to the electric wire arranging parts 22 by the groove-shaped walls 36 which form the electric wire accommodating slots 35.

The fixed contacts 43 of the electric wire connecting terminals 24, 25 and 26 are arranged to fix to the installation positions P1, P2, and P3 of the electric wire connecting terminals 24, 25 and 26, respectively.

In this embodiment, after the electric wires 11a, 11b, 11c and 11d are respectively accommodated orderly on the electric wire arranging part 22, by pushing the electric wire connecting terminals 24, 25 and 26 respectively into the above-mentioned installation positions P1, P2, and P3, as shown in FIG. 3, the electric wire connecting terminals 24, 25 and 26 are fixed to the electric wire arranging part 22 so that the fixed contacts 43 cover the electric wires 11a, 11b, 11c and 11d which are accommodated in the electric wire arranging part 22.

Next, the specific structure of the slider 27 and the structure for giving moderateness are explained.

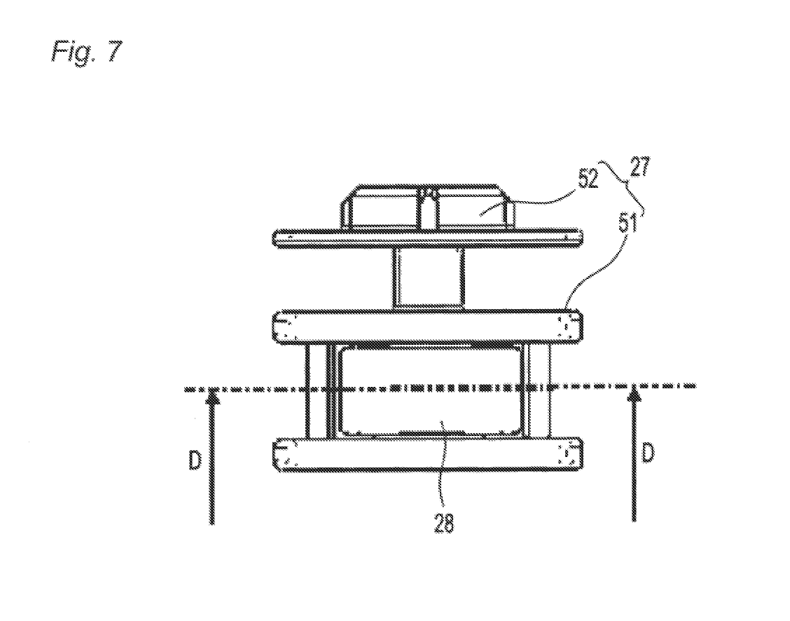

As shown in FIG. 7, the slider 27 includes a slider body 51 which is accommodated in the second case member 33, and a sliding operation part 52 which is integrally formed with the side surface of the slider body 51 and is protruded outside the second case member 33.

The slider body 51 is accommodated and supported in the slider accommodating space 37 of the second case member 33 slidably along the arranging direction (the arrow X4 direction of FIG. 3) of the fixed contacts 43 in the electric wire arranging part 22, as shown in FIG. 3. The internal structure of the slider body 51 is explained in detail later.

The sliding operation part 52 is a handle for moving the slider body 51 in the second case member 33, and is provided by being protruded outside the switch case 23, as shown in FIG. 2. When the slide switch 21 is attached to the switch receiving part 9 of the in-vehicle illuminating device 1, the sliding operation part 52 is connected with the knob 7 for slide operations at the side of the in-vehicle illuminating device 1, and becomes slidable together with the knob 7 for slide operations.

Next, the internal structure of the slider body 51 is explained.

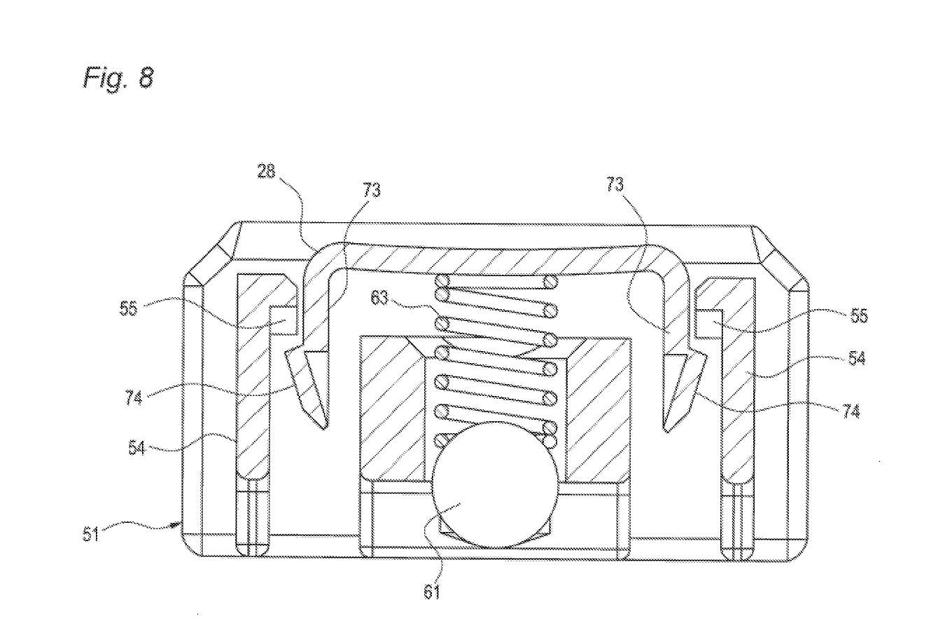

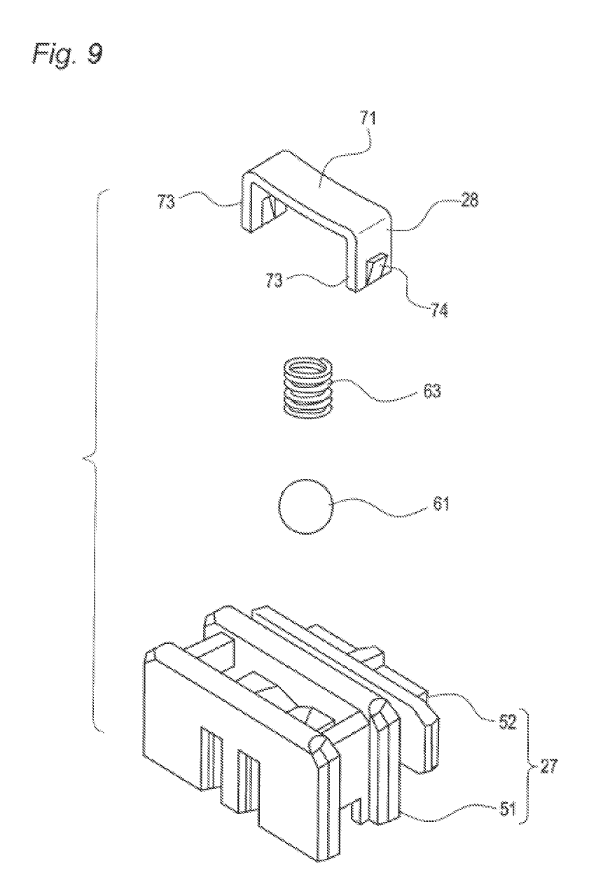

The slider body 51 accommodates inside a ball 61 for giving moderation at the time of sliding, a spring 63 which presses the ball 61 to the wave-like cam surface 38 on the inner bottom of the second case member 33, and the above-mentioned movable connector 28, as shown in FIG. 8 and FIG. 9.

As shown in FIG. 8 and FIG. 9, the movable connector 28 includes a rectangular contact contacting plate 71 which can contacts two adjacent fixed contacts of the three fixed contacts 43 which are fixed to the electric wire arranging part 22, and locking plates 73 which extend from the two ends of the contact contacting plate 71, and has a U shape when viewed from side.

The locking plates 73 at the two ends of the contact contacting plate 71 extend in the direction perpendicular to the contact contacting plate 71, and engaging parts 74 are formed at the front end side by being struck out.

The movable connector 28 is installed into the slider body 51 so that the locking plates 73 at the two ends of the movable connector 28 are inserted into the slider body 51, and the spring 63 contact the rear surface of the contact contacting plate 71. The movable connector 28 is pressed to contact the fixed contacts 43 with the restoring force of the spring 63.

When the locking plates 73 at the two ends of the movable connector 28 are inserted into the slider body 51, as shown in FIG. 8, the engaging parts 74 are engaged with lock parts 55 which are protruded from opposite walls 54 in the slider body 51 so that the movable connector 28 will be locked to the slider body 51. In more detail, in this embodiment, the lock parts 55 regulate the movement (the maximum protruding amount) of the contact contacting plate 71 towards the side of the fixed contacts 43 (electric wire side) so that the movable connector 28 may not contact the sheaths of the electric wires at the time of sliding the slide switch 21.

In this embodiment, as shown in FIG. 3, the movable connector 28 contacts the upper surfaces 36a of the groove-shaped walls 36 which define the electric wire accommodating slots 35 which respectively accommodate the electric wires in a sunk state, so that the movement of the movable connector 28 towards the side of the electric wires is regulated by the upper surfaces 36a.

Both the first mechanism that regulates the position of the movable connector 28 by means of the engagement of the lock parts 55 and the engaging parts 74 shown in FIG. 8, and the second mechanism that regulates the position of the movable connector 28 by means of the upper surfaces 36a of the groove-shaped walls 36 shown in FIG. 3 are means to set the sliding position of the movable connector 28 so that the movable connector 28 will not contact the electric wires which are press-contacted to the electric wire connecting terminals 24, 25 and 26.

For the slide switch 21 of this embodiment, as shown in FIG. 3, a predetermined gap S between each of the electric wires 11a, 11b, 11c and 11d which are orderly accommodated in the electric wire arranging part 22 and the movable connector 28 can be ensured by the above-mentioned first mechanism and second mechanism, and the movable connector 28 can be definitely prevented contacting the electric wires 11a, 11b, 11c and 11d at the time of sliding the slider 27.

After the slider assembly of FIG. 8 to which the ball 61, the spring 63, and the contact contacting plate 71 in the slider body 51 are assembled is finished, the slider 27, as shown in FIG. 3, is assembled into the slider accommodating space 37 of the second case member 33.

As shown in FIG. 3, the second case member 33 to which the slider assembly is assembled is coupled onto the first case member 31 in a direction to make the movable connector 28 to be pressed against the fixed contacts 43.

When the second case member 33 is coupled onto the first case member 31 as shown in FIG. 3, a contact switching part which switches between connections by means of the slide of the slider 27 is laid over the electric wire arranging part 22 in which the plurality of electric wires 11a, 11b, 11c and 11d of the wire harness are press-contacted.

In other words, the slider 27 is slidably supported on the electric wire arranging part 22 so that the movable connector 28 is laid over the fixed contacts 43.

In the assembled slide switch 21 shown in FIG. 3, at the time of sliding the slider 27, the movement of the ball 61 that climbs over the cam surface 38 by overcoming the restoring force of the spring 63 and falls into the valley of the cam surface 38 gives moderateness.

In the slide switch 21 explained above, the pair of fixed contacts 43 which are connected or short circuited by the movable connector 28 are changed with the movement of the movable connector 28 with the slide of the slider 27.

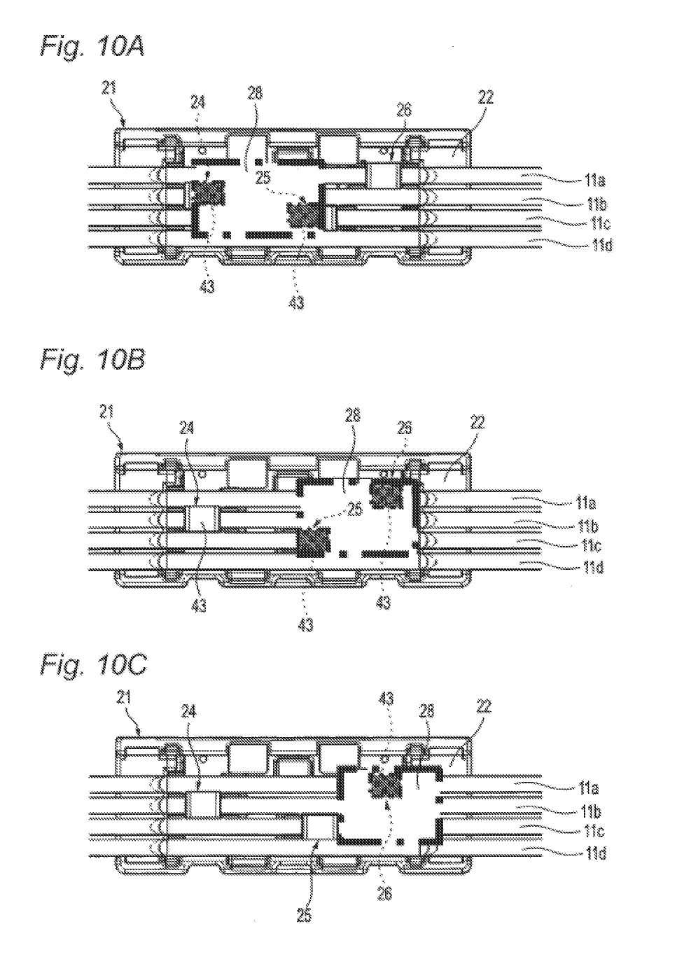

FIGS. 10A to 10C show that the pair of fixed contacts 43 which are connected or short circuited with the slide of the slider 27 are changed. FIG. 10A shows a connection state when the slider 27 is located at the left end in the figure, in which the electric wire connecting terminal 24 and the electric wire connecting terminal 25 are connected or short circuited by the movable connector 28. FIG. 10B shows a connection state when the slider 27 is moved only one moderation from the left end in the figure to the right side, in which the electric wire connecting terminal 25 and the electric wire connecting terminal 26 are connected or short circuited by the movable connector 28. FIG. 10C shows a connection state when the slider 27 is slid and moved to the right end in the figure, in which only the electric wire connecting terminal 26 is connected by the movable connector 28.

In the case of the slide switch 21 of the embodiment explained above, as shown in FIG. 3, the fixed contacts 43 of the electric wire connecting terminals 24, 25 and 26 are arranged on the electric wires 11a, 11b, 11c and 11d accommodated in the electric wire arranging part 22 of the switch case 23, and the movable connector 28 on the slider 27 is further laid over the fixed contacts 43.

Namely, in the case of the slide switch 21 of the embodiment, since the electric wire arranging part 22 in which the plurality of electric wires 11a, 11b, 11c and 11d of the wire harness are press-contacted and the contact switching part which switches between connections by means of the slide of the slider 27 are formed by arranging the contact switching part to be laid over the electric wire arranging part (or vice versa), the dimensions in the plane are cut down as compared with the conventional slide switch in which the electric wire arranging part and the contact switching part are located side by side in a plane. Therefore, the installation space can be reduced.

By arranging the electric wire arranging part 22 to be laid over the contact switching part (or vice versa), the sizes of the components such as the electric wire connecting terminals 24, 25 and 26 can be reduced, and the size and the weight of the slide switch can be reduced with the reduction of the sizes of these components.

The arrangement of the wire harness which attaches to the slide switch can be improved with the reduction of the size of the slide switch.

In the case of the slide switch 21 of the embodiment explained above, the sliding position of the movable connector 28 is set so that the movable connector 28 will not contact the electric wires which are press-contacted to the electric wire connecting terminals 24, 25 and 26.

Therefore, wear of the electric wire sheaths due to the rub of the movable connector 28 can be prevented, and the operational reliability and endurance of the slide switch can be improved.

In the case of the slide switch 21 of the embodiment explained above, the electric wire arranging part 22 includes the electric wire accommodating slots 35 which orderly accommodate the electric wires, the depth of the electric wire accommodating slots 35 is set to be larger than the outer diameter of the electric wires, and the electric wires are accommodated inside the electric wire accommodating slots 35 in a sunk state. The movement of the movable connector 28 towards the side of the electric wires is regulated by the upper surfaces 36a of the groove-shaped walls 36 which define the electric wire accommodating slots 35.

Therefore, the movement position of the movable connector 28 can be definitely regulated to the position where the electric wires in the electric wire accommodating slots 35 are not contacted. With the structure in which the upper surfaces 36a of the groove-shaped wails 36 which define the electric wire accommodating slots 35 are also used to regulate the movement position of the movable connector 28, since a guide structure exclusively used to regulate the movement position of the movable connector 28 or the like is not necessary, the structure of the switch case 23 can also be prevented from becoming complicated.

In the case of the slide switch 21 of the embodiment explained above, the electric wire connecting terminals 24, 25 and 26 includes a pair of the electric wire connecting parts 41 and 41 which are arranged to be opposite to each other and spaced in the longitudinal direction of electric wires, and the fixed contact 43 which connects the upper ends of the pair of electric wire connecting parts 41 and 41 to have a U shape when viewed from side.

Therefore, as shown in FIG. 3, the electric wire connecting terminals 24, 25 and 26 can be easily fixed to the electric wire accommodating slots 35 with stable postures by fitting the pair of the wire connecting parts 41 and 41 located at the two ends of the fixed contacts 43 between the groove-shaped walls 36 of the electric wire accommodating slots 35, and the operation of fixing to the switch case 23 of the electric wire connecting terminals 24, 25 and 26 can be simplified.

Since the plurality of electric wire connecting terminals 24, 25 and 26 can all be finished with the same structure in the case of the slide switch 21 of the embodiment explained above, the electric wire connecting terminal can be prevented from having different types, and the cost can be reduced.

In the above-mentioned embodiment, the first mechanism that regulates the position of the movable connector 28 by means of the engagement of the lock parts 55 at the side of the slider 27 and the engaging parts 74 at the side of the movable connector 28, and the second mechanism that regulates the position of the movable connector 28 by means of the upper surfaces 36a of the groove-shaped walls 36 of the electric wire arranging part 22 are equipped as means to set the sliding position of the movable connector 28 so that the movable connector 28 will not contact the electric wires 11a, 11b, 11c and 11d which are press-contacted to the electric wire connecting terminals 24, 25 and 26. However, even only one of the mechanisms also can regulate the sliding position of the movable connector so that the movable connector will not contact the electric wires which are press-contacted to the electric wire connecting terminals.

Further, the slide switches of the present invention are not limited to the above embodiments, and suitable modifications, improvements and the like can be made. As long as the purpose of the invention can be achieved, materials, shapes, dimensions, forms, quantities, arranging positions of the components illustrated in the above embodiments are arbitrary, and not limited to the embodiments described above.

Although the present invention is described in detail with reference to the embodiments, it is apparent that various modifications and amendments may be made by those skilled in the art without departing from the spirit and scope of the invention.

This application is based on the Japanese patent application (patent application 2009-294210) filed on Dec. 25, 2009, whose contents are incorporated herein by reference.

### INDUSTRIAL APPLICABILITY

According to the slide switch of the invention, since the electric wire arranging part in which the plurality of electric wires of the wire harness are press-contacted and the contact switching part which switches between connections by means of the slide of the slider are formed by arranging the switching part to be laid over the electric wire arranging part (or vice versa), the dimensions in the plane are cut down. Therefore, the installation space can be reduced.

By arranging the electric wire arranging part to be laid over the contact switching part (or vice versa), the sizes of the components such as the electric wire connecting terminals can be reduced, and the size and the weight of the slide switch can be reduced with the reduction of the sizes of these components.

The arrangement of the wire harness which attaches to the slide switch can be improved with the reduction of the size of the slide switch.

### REFERENTIAL SIGNS LIST

1 in-vehicle illuminating device
11a, 11b, 11c and 11d electric wire
21 slide switch
22 electric wire arranging part
23 switch case
24, 25 and 26 electric wire connecting terminal
27 slider
28 movable connector
31 first case member
33 second case member
35 electric wire accommodating slot
36 groove-shaped wall
36a upper surface
37 slider accommodating space
38 cam surface
41 electric wire connecting part
43 fixed contact
51 slider body
52 sliding operation part
54 opposite wall
55 lock part
61 ball
63 spring
71 contact contacting plate
73 lock plate
74 engaging part

1. A slide switch comprising:
a switch case which includes an electric wire arranging part which orderly accommodates a plurality of electric wires;
a plurality of electric wire connecting terminals, each of which includes electric wire connecting parts which are conductively connected to the electric wires at the electric wire arranging part and a fixed contact which is formed integrally with the electric wire connecting parts and is fixed to the switch case;
a slider which is supported by the switch case slidably along an arranging direction of the plurality of fixed contacts on the switch case; and
a movable connector which is equipped in the slider so that the fixed contact with which the movable connector is conductively connected is changed in accordance with a slide of the slider, wherein
the electric wire connecting terminals are fixed to the electric wire arranging part so that the fixed contacts cover the electric wires accommodated in the electric wire arranging part, and
the slider is slidably supported on the electric wire arranging part so that the movable connector is laid over the fixed contacts.

2. The slide switch according to claim 1, wherein
a position where the movable connector slides is set so that the movable connector does not contact the electric wires which are press-contacted to the electric wire connecting terminals.

3. The slide switch according to claim 2, wherein
the electric wire arranging part includes electric wire accommodating slots which orderly accommodate the electric wires, a depth of the electric wire accommodating slots is larger than an outer diameter of the electric wires so that the electric wires are accommodated inside the electric wire accommodating slots in a sunk state, and
a movement of the movable connector towards a side of the electric wires is regulated by an upper surfaces of groove-shaped walls which define the electric wire accommodating slots.

4. The slide switch according to claim 1, wherein
each of the electric wire connecting terminals has a U shape viewed from side by a pair of the electric wire connecting parts which are arranged to be opposite to each other and spaced in a longitudinal direction of the electric wires, and the fixed contact which connects upper ends of the pair of electric wire connecting parts.
